(19) United States
(12) Patent Application Publication
(10) Pub. No.: US 2010/0134260 A1
(43) Pub. Date: Jun. 3, 2010

(54) Method of Tracking Items Using RFID

(75) Inventors: Michael W. McDaniel, Sunshine, LA (US); Daniel J. Cadigan, Baton Rouge, LA (US)

Correspondence Address: CAROL WILSON;BP AMERICA INC., MAIL CODE 5 EAST, 4101 WINFIELD ROAD, WARRENVILLE, IL, 60555, US

(73) Assignee: BP Corporation North America Inc., Warrenville, IL (US)

(21) Appl. No.: 12/445,417

(22) PCT Filed: Sep. 27, 2007
(86) PCT No.: PCT/US2007/079656

§ 371 Date: Jan. 15, 2010

Related U.S. Application Data
(60) Provisional application No. 60/829,585, filed on Oct. 16, 2006.

(51) Int. Cl. G06K 7/01

(52) U.S. Cl. 340/10.42

(57) ABSTRACT

Methods for accounting for an managing inventory and accounting for goods is disclosed. An RFID tag in the form of an RFID inlay is placed in the interior of a carton, pallet or other container for shipping or storing items. RFID readers can be used to elicit identification information from the RFID inlay within a carton. Such method reduces waste paper and cost. The rate of application of the RFID tag can also be increased using the disclosed methods. Reliability of reading information from the RFID inlay within a carton is improved in comparison to traditional slap and ship RFID labels.

### BACKGROUND OF THE INVENTION

This invention relates to systems and methods for accounting for items, such as inventory or other goods, using radio frequency identification.

Radio frequency identification (RFID) technology has many applications ranging from toll road collection systems to asset management systems. Typically, an RFID system has one or more transponders (also called “tags”) and at least one receiver. As used in this application, “RFID tag” means an RFID chip and antenna and may include additional circuitry, for example additional memory or a transmitter. Depending on the application, the receiver may be accompanied by a transmitter and may communicate with other devices. Such communication may use wires or may be wireless.

One of the major applications for RFID technology is to keep track of assets ranging from inventory to equipment or even people. Typically, in this type of application, a label with an RFID tag is attached to the item or a person is issued an identification card with an RFID tag.

RFID tags can be passive, semi-passive or active. Passive tags do not have an internal power source. A small electric current is generated by an incoming radio frequency which provides enough power for the tag to send a responding signal. The tags responding signal may simply be an identification number, however, passive tags can be designed to store additional information, for example in non-volatile memory. Such stored additional information may be transmitted by the tag in response to an incoming radio frequency or can be otherwise obtained from the tag. A device typically referred to as a reader, reads the signal from the tag. The reader may be part of the device which initially sent a signal to the RFID tag or it can be a separate device. The lack of an internal power source allows passive tags to be relatively small in comparison to other types of tags. However, the lack of internal power also limits the tag's signal strength. For example, many passive tags can not send a signal more than about 2 meters and the distance is usually much less.

Semi-passive tags contain a small battery allowing better response and, therefore, are typically easier to read than passive tags. Because a battery is present, semi-passive tags generally can not be made as thin as passive tags.

Active tags have an internal power source which allows the tag to send out a signal without being prompted by an incoming signal. Typically a signal is sent by an active tag on a predetermined periodic basis, for example every 2 seconds. However, some active tags may include sensors or other devices and may alter the pattern or content of its signal based on such sensors. For example, an active tag may be accompanied by a thermocouple device for sensing temperature. Such a tag could be programmed to start signaling only once a certain temperature is sensed. Such a tag could be programmed to vary the period between signals depending upon the temperature sensed. Such a tag could also be programmed to alter its emitted signal based upon sensed temperature.

Passive tags are frequently used as identifications badges or for access control where a user brings the tag in the vicinity of a reader. Such a reader generally transmits a signal and elicits a response from the passive tag which includes information identifying the tag. The identification information is used, typically by other systems, to verify the credentials of the tag. Passive tags are also used for inventory control or theft deterrence wherein a tag is affixed to an article and, as the article and tag pass in the vicinity of a reader, the information may be logged or an alarm triggered.

Active tags are commonly used on vehicles as a method to pay tolls. Typically, the tag passes within range of a reader which reads the signal and sends the information to a gateway or central computer which charges the toll to the user's account.

Another example of use is described in U.S. Published Patent Application 2004/0160323 which describes use of RFID transponders for a security system. U.S. Published Patent Application 2005/0024183 describes an RFID tag which is part of a uniform or other clothing and is used for identification.

There is great interest in using RFID technology to locate objects or people. EP 1,566,756 describes a system for tracking objects. JP2004288119 describes use of RFID technology to track entry/exit of people for security and safety purposes.

A common method of tracking inventory or similar items using RFID tags is to fabricate a label using an RFID inlay and attach such a label to the exterior of a package. RFID readers are then placed in locations where such inventory is expected to pass, for example at doorways or other points of entry or egress, in distribution centers and even at the store level to account for the inventory at various points in the distribution chain. One major retailer has asked its top suppliers to affix RFID tags onto cartons for improved management of inventory.

Although use of RFID can greatly improve distribution and management of inventory, several hurdles exist to widespread adoption of RFID for such purpose. Cost is a significant barrier for many potential users. Another barrier is the rate at which RFID labels can be applied packages. Another concern is the reliability of being able to read information from the RFID tag. Because of reliability concerns, RFID tags are traditionally converted into labels and affixed to the exterior of cartons. There is also a concern with the waste generated from RFID labels, particularly if used widely, and there is interest in reducing such waste.

### SUMMARY OF THE INVENTION

We have discovered that RFID tags can be used in the form of an inlay and placed inside cartons without reduction in reliability. In fact, we have surprisingly discovered that the placing an RFID inlay inside a carton, in accordance with the method of this invention, can actually result in improved reliability.

We have also found that waste paper generated from using RFID for tracking inventory can be significantly reduced and costs can also be significantly reduced. We have also found that the method of this invention can allow greater throughput of RFID enabled cartons.

In an embodiment, this invention provides a method of accounting for inventory. he method includes the steps of associating a carton with an RFID inlay; and placing the RFID inlay within the package. The RFID inlay is capable of transmitting a responding signal in response to a signal intended to elicit the responding signal wherein the responding signal includes information identifying the RFID inlay. The responding signal may include additional information.

In some embodiments, this invention provides a method of accounting for packaged goods. The method includes the steps of associating one or more packaged goods with an RFID inlay; placing the one or more packaged goods into a carton; placing the RFID inlay in the carton; transmitting a querying signal from an RFID reader such that a responding signal is elicited from the RFID inlay which responding signal includes identification information identifying the RFID inlay; and using the identification information to identify the one or more packaged goods.

In another embodiment, this invention provides a method of accounting for goods in a carton. The method includes the steps of a) writing information about goods into memory of an RFID inlay; placing the goods in a carton; placing the RFID inlay in the carton; and reading the information about the goods from the memory of the RFID inlay.

In another embodiment, this invention is a method of managing inventory. The method includes the steps of positioning a carton having an RFID inlay within in the vicinity of an RFID reader; sending a transmitted signal to the RFID inlay; eliciting a responding signal from the RFID inlay using the transmitted signal which responding signal includes information identifying the carton; and correlating the identifying information with known information about the carton.

In any embodiment, the RFID inlay can be imprinted for example with an RFID number, logo or other information. In any embodiment, the RFID inlay may be affixed or otherwise secured to a surface within the carton.

### DESCRIPTION OF THE PREFERRED EMBODIMENT(S)

This invention provides a method of accounting for items. This invention provides reduction in waste paper in comparison to traditional methods and greatly expands the availability, utility and affordability of RFID tracking systems. This invention provides a method that can the used more quickly than traditional methods. Surprisingly, this invention also provides a method for tracking inventory that has a greater percentage read rate than traditional methods.

In accordance with this invention, an RFID inlay is used. An RFID inlay, typically called a dry inlay, is an RFID chip and antenna with a housing. The housing serves as a carrier for the chip and antenna and provides greater durability than chip and antenna alone. Commonly, a thin sheet of material, typically a plastic or other polymer is used as the housing and the chip and antenna are imbedded into the housing. However, other forms of housings can be used as long as they provide sufficient durability while allowing communication between the RFID tag and RFID readers.

Traditionally, RFID inlays are converted into a label before being used for tracking items. Generally, in such conversions, a paper backing and a paper label are applied to the inlay and an adhesive applied to the paper backing. Other label materials can be used such as polymers or hybrid materials. Such converted RFID inlays are referred to herein as RFID labels. Purveyors of goods typically print information on the label and secure the label to the outside of a package for shipping a process commonly referred to as the “slap and ship” method. As used herein, a package for shipping or transporting goods is referred to as a “carton” and includes pallets, shipping containers and containers for transporting and storing goods.

In accordance with this invention, an RFID inlay is not subjected to traditional conversion processes in that it is not converted into a paper label or other traditional RFID label for use on the exterior of a carton. In some embodiments, information is printed onto the RFID inlay. Such information may include an RFID identification code, for example a hexadecimal code, and may also product information and additional information such as logos or other information associated with the product, a company or the coding system used.

By avoiding traditional conversion processes, this invention can reduce waste paper or other RFID label material. Traditional conversion processes lead to paper waste in the form of the paper label and its associated backing paper. A substantial amount of paper ultimately ends up in the waste stream. In traditional processes, 4500 pounds of paper waste is created for every 1,000,000 RFID labels used. The estimated total number of cartons being supplied to U.S. retailers alone is in the hundreds of millions each year. Therefore, avoiding the traditional conversion process can result in significant reduction of paper waste.

Another advantage of avoiding the traditional conversion process in accordance with this invention is a dramatic reduction in the cost for using RFID to track cartons. Although RFID for tracking inventory has numerous known benefits, it is commonly said that RFID use will be limited unless the cost can be reduced to below ten cents. Currently, in the U.S., RFID labels made using traditional conversion processes can range from 15 to 30 cents and up. This cost is prohibitive to many suppliers and manufacturers. The method of this invention can reduce the cost of an RFID tag to below the ten cent threshold because RFID inlays can currently be purchased for as little as 7.9 cents. Wider use of RFID is expected to reduce the costs further. Therefore, this invention permits wider use of RFID for tracking and accounting for inventory leading to more efficient management.

In accordance with this invention, the RFID inlay is placed inside the carton. The RFID inlay may be placed in the carton before, after or during the process of placing goods in the carton. In some embodiments, an RFID inlay is dropped into a carton after goods have been placed into the carton. Such drops can be accomplished using machinery typically used for including literature, coupons, rebate material or other like materials into a carton. The RFID inlay can optionally be secured to a surface within a carton. In some embodiments, an RFID inlay is secured to the interior of a package, for example using adhesive material or a fastening device. In other embodiments, an RFID inlay is affixed or otherwise secured to one or more items being placed into a carton.

Traditional slap and ship placement of RFID labels can be a limiting processes in shipping because, often, machines for such placement can only process roughly 40 cases per minute. Traditional slap and ship placement of RFID labels is often a rate limiting step in the production and shipping process and, often, requires use of multiple machines for each packaging line which leads to increased associated purchase, maintenance and operation costs. This rate limitation represents another significant barrier to widespread use of RFID for tracking of cartons.

This invention is not limited to traditional slap and ship rates because an RFID inlay is placed inside a carton. For example, in some embodiments an RFID inlay is dropped into a package using machinery typically used for including literature, coupons rebates and other like materials. Such machinery can be faster than traditional slap and ship machinery achieving rates of, for example, 60 cartons per minute.

Another significant concern with use of RFID labels is reliability in reading the RFID label. Such reliability level is commonly referred to as the “read rate.” Concern over read rate is one reason RFID labels have traditionally been placed on the exterior of cartons. In use, a carton having an RFID tag receives a signal from an RFID reader or other source which elicits a responding signal from the RFID tag. It was generally believed that placing an RFID tag inside the carton would reduce the effectiveness of such signal communication. Information in the responding signal is used to identify the RFID tag and is correlated to known information. For example, information received from the source of the carton concerning the carton identification and contents.

For example, a manufacturer may communicate information to one or more intended recipient which information can include the RFID tag identification number and additional information such as the information about the contents of the carton. Recipients may include ultimate and/or intermediate recipients. Identification information elicited from the RFID tag can then be correlated by the recipient to the information received from the manufacturer.

It is commonly believed that placing RFID tags inside cartons would reduce read rate. We have surprisingly discovered that, contrary to what was believed, the method of this invention can provide improved read rates compared to read rates achieved using RFID labels placed on the exterior of cartons.

Trials conducted as described below surprisingly revealed a 10% increase in read rate over traditional exterior application of RFID labels. In particular, use of the invention achieved read rates exceeding 90%.

Without being held to any particular theory, it is believed that elimination of traditional conversion and slap and stick application processes better preserves the integrity of the RFID tag and improves communication between the RFID tag and an RFID reader.

Without limiting the scope of this invention, the following example illustrates an embodiment of this invention.

### EXAMPLE

RFID inlays were encoded and imprinted with an RFID information code, product information and the Electronic Product Code logo. The RFID inlays used were Avery Dennison AD-220 RFID dry inlays. The RFID inlays were imprinted and encoded using a Zebra R110Xi printer containing a ThingMagic™ RFID encoder/decoder. The 4.75 inch wide rolls of inlays were cut to 4.25 inch width to fit into the printer.

RFID inlays as described above were dropped into cartons, at a rate of about 60 cartons per minute, for supply to a major retailer and the cartons were shipped to one of the retailer's distribution centers. The distribution center supplied over 60 retail stores. The distribution center an associated stores were equipped with RFID readers for tracking inventory of product cartons. Read rates for the RFID inlays placed within cartons were in the range from about 93% to about 97%. In comparison, read rates for identical cartons using RFID labels placed on the exterior of cartons where in the range from about 83% to about 87%.

The results of the trail showed significant reduction is waste paper and in cost. The trial also demonstrated that RFID inlays placed within cartons in accordance with this invention could be reliably read. Surprisingly, we found that the read rate significantly increased using the method of this invention in comparison to traditional RFID label application.

1. A method of accounting for inventory, the method comprising the steps of:
a) associating a carton with an RFID inlay and
b) releasing the RFID inlay into the carton;
such that the RFID inlay is capable of transmitting a responding signal in response to a signal intended to elicit the responding signal wherein the responding signal includes information identifying the RFID inlay.

2. The method of claim 1 wherein the RFID inlay is imprinted with at least an RFID number.

3. (canceled)

4. A method of accounting for packaged goods, the method comprising the steps of:
a) associating one or more packaged goods with an RFID inlay;
b) placing the one or more packaged goods into a carton;
c) releasing the RFID inlay into the carton;
d) transmitting a querying signal from an RFID reader such that a responding signal is elicited from the RFID inlay which responding signal includes identification information identifying the RFID inlay; and
e) using the identification information to identify the one or more packaged goods.

5. A method of accounting for goods in a carton, the method comprising the steps of:
a) writing information about goods into memory of an RFID inlay;
b) placing the goods in a carton;
c) releasing the RFID inlay into the carton; and
d) reading the information about the goods from the memory of the RFID inlay.

6. A method of managing inventory, the method comprising the steps of:
a) releasing an RFID inlay into a carton;
b) positioning the carton in the vicinity of an RFID reader;
c) sending a transmitted signal to the RFID inlay;
d) eliciting a responding signal from the RFID inlay using the transmitted signal which responding signal includes information identifying the RFID inlay; and
e) correlating the identifying information with known information about the carton.
